(19) United States
(12) Patent Application Publication
(10) Pub. No.: US 2007/0058067 A1
(43) Pub. Date: Mar. 15, 2007

(54) Monitoring system

(75) Inventors: Makoto Tsugita, Saitama (JP); Atsushi Misawa, Sitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/510,593

(22) Filed: Aug. 28, 2006

(30) Foreign Application Priority Data
Sep. 14, 2005 (JP) 2005-266959

(51) Int. Cl. G02B 13/16

(52) U.S. Cl. 348/335

(57) ABSTRACT

A monitoring system is provided, for monitoring a room in all directions and capturing a high quality image of a subject when a change in the subject is detected. The monitoring system according to the present invention includes: an image capturing section; a convex mirror section for reflecting a whole image to the direction of the image capturing section; a plane mirror section for reflecting the partial image to the direction of the image capturing section; and a control device for controlling to switch an image capturing target between the convex mirror section and the plane mirror section. The control device includes: a whole image acquiring section for acquiring a whole image when the image capturing target is the convex mirror; a change detecting section for detecting a change in the subject of the whole image; an image capturing target control section for switching the target captured by the image capturing section to the plane mirror section when any change in the subject is detected; and a partial image acquiring section for acquiring the partial image when the image capturing target is the plane mirror.

### CROSS REFERENCE

The present application relates to and claims priority from a Japanese Patent Application No. 2005-266959 filed in Japan on Sep. 14, 2005, the contents of which are incorporated herein by reference for all purpose.

### BACKGROUND OF THE INVENTION

1. Field of the Invention

The present invention relates to a monitoring system. Particularly, the present invention relates to a monitoring system for monitoring in all directions.

2. Related art

Recently, a monitoring system using an image capturing apparatus is provided in various locations to detect an intruder. In an image capturing apparatus used for a conventional monitoring system, the angle of field is limited, so that it is limited to cover an image capturing region by a single image capturing apparatus. Therefore, a plurality of image capturing apparatuses are installed or an image capturing apparatus with a wide angle lens having a wide angle of field is used to broaden the image capturing region in order to cover a wide range of the image capturing region.

Additionally, a monitoring apparatus which captures the wide range of the image capturing region all together using an omnidirectional camera with a convex mirror and previously sets the priority of monitoring in a plurality of monitoring regions to monitor according to the priority set in the monitoring region is disclosed, for example, in Japanese Patent Application Publication No. 2003-151039.

The monitoring apparatus is required to capture images in a wide range in order to monitor the behavior of a person detected in the image capturing region. Additionally, the monitoring apparatus is also required to acquire an image with the quality sufficient to identify the person detected within the monitoring region. However, when a plurality of image capturing apparatuses are used, the cost is increased to secure the place to install the image capturing apparatuses and to maintain the image capturing apparatuses. Further, when the image capturing apparatus with a wide angle lens is used, the behavior of an intruder can be detected, but it is difficult to identify the intruder because the resolution per unit monitoring area is reduced. Meanwhile, when the image capturing apparatus with high resolution is used to identify the intruder, the cost of the image capturing apparatus is increased. Here, in order to identify the intruder, the wide angle lens of the image capturing apparatus can be automatically replaced to zoom and capture the intruder, but it takes time to replace the lens. Additionally, when the lens is replaced, it takes time to prevent the axis of lens from displacing, and to prevent the lens from damaging due to causing the lens to mechanically operate.

In the above-described conventional art, an image is captured in all directions using a convex mirror. Additionally, when the image of a subject with high resolution is captured, the subject shown on the convex mirror is enlarged and captured the same. That is to say, the image in the wide range shown on the convex mirror is captured and the portion on which the subject is shown is enlarged, so that the number of pixels in the region on which the subject is shown in the captured image is reduced. Therefore, it is limited to capture the image of the subject with high resolution and it is difficult to recognize the face of the subject, so that the person can not be identified sometimes.

### SUMMARY OF THE INVENTION

Thus, it is an object of the present invention to provide a monitoring system which is capable of solving the problem accompanying the conventional art. The above and other objects can be achieved by combining the features recited in independent claims. Then, dependent claims define further effective specific example of the present invention.

A first aspect of the present invention provides a monitoring system. The monitoring system includes: an image capturing section; a convex mirror section for reflecting a surrounding whole image in the direction of the image capturing section; a plane mirror section for reflecting a partial image included in the whole image reflected by the convex mirror section to the direction of the image capturing section; and a control device for controlling to switch the target captured by the image capturing section between the convex mirror section and the plane mirror section. The control device includes a whole image acquiring section for acquiring the whole image reflected on the convex mirror section when the target captured by the image capturing section is the convex mirror section; a change detecting section for detecting the change in the behavior of the subject in the whole image acquired by the whole image acquiring section; an image capturing target control section for switching the target captured by the image capturing section from the convex mirror section to the plane mirror section when the change detecting section detects that the subject of the whole image is changed; and a partial image acquiring section for acquiring a partial image reflected on the plane mirror section when the target captured by the image capturing section is the plane mirror section.

The plane mirror section may further include a plurality of plane mirrors continuously disposed along the circumference of the convex mirror section, for reflecting each of the plurality of partial images included in the whole image reflected by the convex mirror section to the direction of the image capturing section. The control device may further include a changed direction specifying section for specifying the direction of the region in which the behavior of the subject is changed in the whole image acquired by the whole image acquiring section when the change detecting section detects that the subject of the whole image is changed; and a plane mirror section selecting section for selecting a plane mirror for reflecting the partial image in the region in the direction specified by the changed direction specifying section to the direction of the image capturing section. The image capturing target control section may switch the target captured by the image capturing section from the convex mirror section to the plane mirror section by changing the image capturing direction of the image capturing section. Then, the convex mirror section and the plane mirror section may be disposed on the ceiling of a room. The image capturing section may be disposed below the convex mirror section.

The plane mirror section may be disposed on the rear face of the convex mirror section. The control device may further include a changed direction specifying section for specifying the direction of the region in which the behavior of the subject is changed in the whole image acquired by the whole image acquiring section when the change detecting section detects that the subject of the whole image is changed. The image capturing target control section may switch the target captured by the image capturing section from the convex mirror section to the plane mirror section by reversing the convex mirror section and change the orientation of the plane mirror section to the direction of the region specified by the changed direction specifying section. Then, the image capturing section may be disposed on the ceiling of a room. The convex mirror section and the plane mirror section may be disposed below the image capturing section.

The monitoring system may further include a horizontal rotating axis for rotating the convex mirror section and the plane mirror section along the vertical direction, and a vertical rotating axis for rotating the convex mirror section and the plane mirror section along the horizontal direction. The image capturing target control section may switch the target captured by the image capturing section from the convex mirror section to the plane mirror section by rotating the horizontal rotating axis to reverse the convex mirror section, and also may change the orientation of the plane mirror section to the direction of the region specified by the changed direction specifying section by rotating the vertical rotating axis. Additionally, the monitoring system may further include a focus control section for controlling the focal position of the image capturing section dependent on whether the target captured by the image capturing section is the convex mirror section or the plane mirror section. The partial image acquiring section may acquire the partial image of which number of pixels is more than that of the whole image acquired by the whole image acquiring section.

Here, all necessary features of the present invention are not listed in the summary of the invention. The sub-combinations of the features may become the invention.

According to the present invention, the monitoring in all directions in a room can be achieved, and the image of a subject with high resolution can be captured when it is detected that the behavior of the subject is changed.

### BRIEF DESCRIPTION OF THE DRAWINGS

FIG. 1 is a conceptual diagram of a monitoring system 10;

FIG. 2 is a block diagram of the functional configuration of the monitoring system 10;

FIG. 3 is a flow chart showing a processing of the monitoring system 10;

FIG. 4 is a conceptual diagram of a monitoring system 12;

FIG. 5 is a block diagram of the functional configuration of the monitoring system 12;

FIG. 6 is a flow chart showing a processing of the monitoring system 12;

### DETAILED DESCRIPTION OF THE INVENTION

Hereinafter, the present invention will now be described through preferred embodiments. The embodiments do not limit the invention according to claims and all combinations of the features described in the embodiments are not necessarily essential to means for solving the problems of the invention.

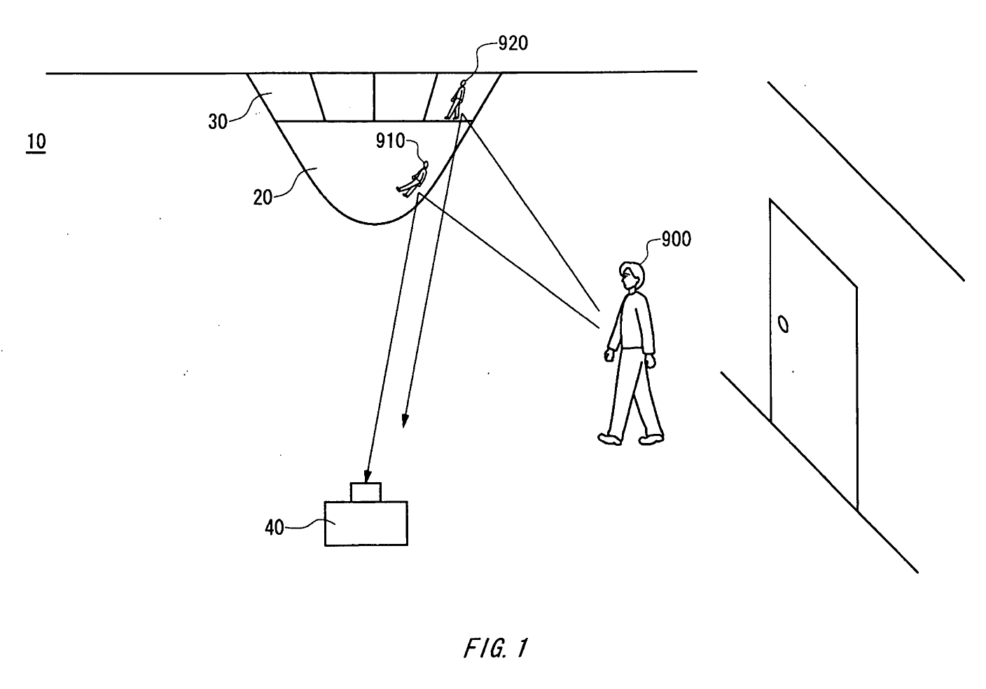

FIG. 1 shows an example of a conceptual diagram of a monitoring system 10 according to an embodiment of the present invention. The monitoring system 10 includes a convex mirror section 20, a plane mirror section 30 and an image capturing section 40. The monitoring system 10 captures the whole image on which the room is shown in all directions, which is shown on the convex mirror section 20 provided that a subject 900 such as a person is not shown on the convex mirror section 20. Then, when the subject 900 such as a person enters the room and the behavior of the subject 900 is changed, the monitoring system 10 captures a partial image including the subject 900, which is shown on the plane mirror section. The monitoring system 10 according to the present embodiment aims to monitor a room in all directions and to capture the image of the subject with high quality when it is detected that the subject 900 is changed.

In the image capturing system 10, the convex mirror section 20 and the plane mirror section 30 are disposed on the ceiling of the room, and the image capturing section 40 is disposed below the convex mirror section 20. When the subject 900 such as a person is not in an image capturing region in the initial state, a target captured by the image capturing section 40 is set to the convex mirror section 20, and the image capturing section 40 captures the surrounding whole image reflected by the convex mirror section 20. Then, when the subject 900 enters the room, the monitoring system operates as follows. 1) The whole image captured by the image capturing section 40 before the subject 900 is captured is compared with the whole image ion which an image 910 of the subject 900 reflected by the convex mirror section 20 is shown to detect whether the behavior of the subject is changed and the behavior of the subject 900.

2) When it is detected that the subject 900 is changed, the target captured by the image capturing section 40 is switched from the convex mirror section 20 to the plane mirror section 30 corresponding to the direction of the region in which the behavior of the subject 900 is changed in the captured whole image. Then, the image capturing section 40 captures a partial image of an image 920 of the subject 900 shown on the plane mirror section 30. Since the partial image shown on the plane mirror section 30 is shown within an area smaller than the convex mirror section 20, the number of pixels of the subject 900 included in the partial image is more than the number of pixels of the subject 900 included in the whole image. Therefore, the partial image of which quality is higher than that of the whole image. Here, after the image capturing section 40 captures the partial image of the subject 900, the monitoring system 10 may turn back the target captured by the image capturing section 40 to the convex mirror section 20. The monitoring system can monitor the behavior of the subject 900 by capturing the subject 900 through the convex mirror section 20.

The monitoring system 10 according to the present embodiment can monitor the room in all directions through the convex mirror section 20 and monitor the behavior of the subject 900. Then, when the monitoring system 10 detects a change in behavior of the subject 900, the image of the subject 900 can be captured through the plane mirror section 30. Thereby the behavior of the subject 900 can be monitored in the room in all directions and the subject 900 with high quality can be captured when a change in the behavior of the subject 900 is detected.

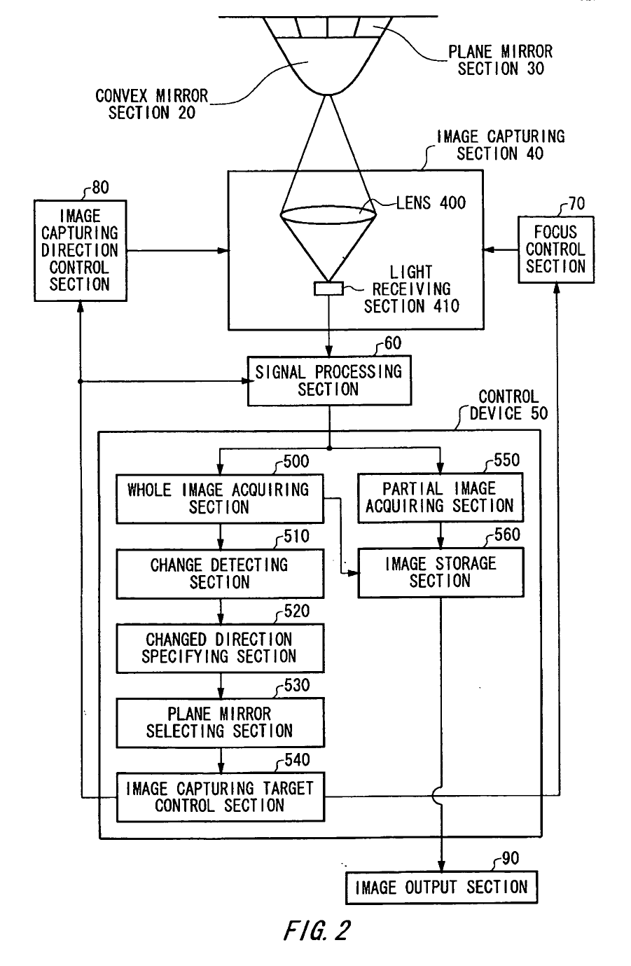

FIG. 2 is a block diagram of the functional configuration of the monitoring system 10 according to the present embodiment. The monitoring system 10 includes the convex mirror section 20, the plane mirror section 30, the image capturing section 40, a control device 50, a signal processing section 60, a focus control section 70, an image capturing direction control section 80 and an image output section 90. Additionally, the image capturing section 40 includes a lens 400 and a light receiving section 410. The control device 50 includes a whole image acquiring section 500, a change detecting section 510, a changed direction specifying section 520, a plane mirror selecting section 530, an image capturing target control section 540, a partial image acquiring section 550 and an image storage section 560.

The convex mirror section 20 reflects an image in all directions (360 degree) i.e. the whole image surrounding the convex mirror 20 to the direction of the image capturing section 40. Meanwhile the plane mirror section 30 reflects the partial image included in the whole image reflected by the convex mirror 20 to the direction of the image capturing section 40. Additionally, the plane mirror 30 may be continuously disposed along the circumference of the convex mirror section 20 and may have a plurality of plane mirrors for reflecting each of the plurality of partial images included in the whole image reflected by the convex mirror section 20 to the direction of the image capturing section 40. Then, the convex mirror section 20 and the plane mirror section 30 may be disposed on the ceiling of the room.

The image capturing section 40 captures the whole image reflected by the convex mirror section 20 or the partial image reflected by the plane mirror section 30. Here, the image captured by the image capturing section 40 may be a moving image and a still image. Additionally, the image capturing section 40 may be disposed below the convex mirror section 20. The image capturing section 40 causes the light receiving section 410 to receive light through the lens 400. Then, the light receiving section 410 receives light to acquire a captured image. The light receiving section 410 provides the acquired captured image to the signal processing section 60. Here, there is no subject 900 such as a person in an image capturing region in the initial state, the image capturing section 40 may capture the whole image reflected by the convex mirror section 20. Thereby the behavior of the subject 900 can be monitored. The signal processing section 60 may perform an image processing such as a white balance correction processing and a gamma correction processing on the captured image acquired from the light receiving section 410. The signal processing section 60 provides the captured whole image to the whole image acquiring section 500 provided that the image capturing section has captured the whole image.

The control device 50 controls to switch the target captured by the image capturing section 40 between the convex mirror section 20 and the plane mirror section 30. Firstly, when there is no subject 900 in an image capturing section in the initial state, the control device 50 may previously set the target captured by the image capturing section 40 to the convex mirror section 20. Then, when the target captured by the image capturing section 40 is the convex mirror section 20, the whole image acquiring section 500 receives the whole image reflected by the convex mirror section 20, which is captured by the image capturing section 40 from the signal processing section 60. The whole image acquiring section 500 provides the whole image received from the signal processing section 60 to the change detecting section 510 and the image storage section 560.

The change detecting section 510 detects a change in the behavior of the subject 900 of the whole image acquired by the whole image acquiring section 500. The change detecting section 510 matches the whole image captured in the state that there is no subject 900 in the image capturing region with the whole image captured by the image capturing section 40 to detect whether there is the subject 900. In this case, the change detecting section 510 may calculate the position of the image 910 of the subject 900 in the convex mirror section 20. For example, the change detecting section 510 sets a coordinate axis such as a polar coordinate on the basis of a point of the convex mirror 20 at which the lens 400 included in the image capturing section 40 and the optical axis are corresponded. Then, the change detecting section 510 may calculate the position of the image 910 of the subject 900 in the convex mirror section 20, which is shown on the convex mirror section 20.

The change detecting section 510 may detect the presence or absence of the subject 900 in the image capturing region, the behavior of the subject 900 and a movement vector of the subject 900 using an image processing method such as a matching method and a gradient method. Detecting the movement vector of the subject 900, the change detecting section 510 may calculate a prediction position at which the image 910 of the subject 900 is in the convex mirror section 20 after it is detected that there is the subject 900 in the image capturing region, and then a predetermined period passes. The change detecting section 510 provides information indicating that the change in the behavior of the subject 900 of the whole image is detected, positional information of the subject 900 in the convex mirror 20 and the prediction position of the subject 900 to the change direction specifying section 520.

Receiving information indicating that the change in the behavior of the subject 900 of the whole image is detected from the change detecting section 510, the change direction specifying section 520 specifies the direction of the region in which the behavior of the subject 900 is changed in the whole image acquired by the whole image acquiring section 500. The changed direction specifying section 520 may calculate the direction of the region in which the behavior of the subject 900 is changed based on the positional information indicative of the position of the image 910 of the subject 900 in the convex mirror section 20, which is received from the change detecting section 510. For example, the change direction specifying section 520 may specify the direction from the center of the convex mirror section 20 toward the image 910 of the subject 900 shown on the convex mirror section 20 as the direction of the region in which the behavior of the subject 900 is changed. Here, when the changed direction specifying section 520 specifies the direction of the region in which the behavior of the subject 900 is changed, the coordinate such as a polar coordinate which is set in the change detecting section 510 may be used. Additionally, the change detecting section 510 has calculated the prediction position at which the image 910 of the subject 900 is in the convex mirror 20, the changed direction specifying section 520 may specify the direction of the region in which the behavior of the subject 900 is changed in the whole image based on the prediction position of the image 910 of the subject 900 calculated by the change detecting section 510.

When it is detected that a plurality of subjects' behaviors are changed in the whole image, the changed direction specifying section 520 may set the priority of the direction of the region in which the behavior of the behavior of the subject is changed based on the occupied area of the subject in the whole image to specify the direction of the region in which the behavior of the behavior of the subject is changed. Specifically, when it is detected that the plurality of subjects' behaviors are changed in the whole image, the changed direction specifying section 520 calculates the occupied area for each of the image of the subject in the whole image. Then, the changed direction specifying section 520 may set the priority in the direction of the region in which the behavior of the behavior of the subject is changed based on the size of the area of the calculated subject image in the whole image. For example, when the area of the subject calculated by the changed direction specifying section 520 in the whole image is larger, the priority of the direction of the region in which the behavior of the subject is changed may be set higher. The changed direction specifying section 520 provides information indicating that the change in the behavior of the subject in the whole image is detected, information indicative of the section specified as the direction of the region in which the behavior of the subject is changed and the priority set to the direction of the region in which the behavior of the subject is changed to the plane mirror selecting section 530.

The plane mirror selecting section 530 selects a plane mirror reflecting the partial image in the direction including the region in which the behavior of the subject 900 specified by the change direction specifying section 520 is changed to the direction of the image capturing section 40. Here, the plane mirror selecting section 530 may store positional information on the plurality of plane mirrors corresponding to a predetermined region of the convex mirror 20 in association with an identifier to uniquely identify the plurality of plane mirrors included in the plane mirror section 30. Additionally, the plane mirror selecting section 530 sets a coordinate based on the condition that the optical axis of the image capturing section 40 and the center of the convex mirror section 20 are matched. Then, the plane mirror selecting section 530 may store the amount of change for changing the image capturing direction of the image capturing section 40 in the case that the image capturing section 40 is directed to the direction of a certain plane mirror in order to capture the partial image. The amount of change may be an angle for rotating the image capturing section 40 from a position at which the image capturing section 40 is in the initial state to a position at which the image capturing section 40 can capture a certain plane mirror when the image capturing section 40 is rotated to change the image capturing direction thereof. Additionally, the amount of change may be the amount of movement for moving the image capturing section 40 from the position at which the image capturing section 40 is in the initial state.

Then, the plane mirror selecting section 530 selects a plane mirror based on information indicative of the direction of the region in which the behavior of the subject 900 is changed, which is received from the changed direction specifying section 520 and which is specified by the changed direction specifying section 520. The plane mirror selecting section 530 may select a plane mirror disposed corresponding to the region of the convex mirror section 20 including the region in which the behavior of the subject 900 is changed. Here, if the changed direction specifying section 520 sets the priority to the region in which the behavior of the subject 900 is changed, the plane mirror selecting section 530 may select the plane mirror based on the priority set by the changed direction specifying section 520. Additionally, the changed direction specifying section 520 specifies the direction of the region in which the behavior of the subject 900 is changed based on the prediction position of the subject 900 calculated by the change detecting section 510, the plane mirror selecting section 530 may select the plane mirror based on the prediction position. Thereby even if the subject 900 is shown over the plurality of plane mirrors, the plane mirror on which the partial image including the subject 900 is shown can be appropriately selected. The plane mirror selecting section 530 provides information indicating that a change in the behavior of the subject 900 of the whole image is detected, the identifier of the selected plane mirror and the amount of change for directing the image capturing section 40 to the direction of the selected plane mirror to the image capturing target control section 540.

The image capturing target control section 540 switches the target captured by the image capturing section 40 from the convex mirror section 20 to the plane mirror section 30 when the change detecting section detects a change in the behavior of the subject 900 of the whole image. Specifically, the image capturing target control section 540 switches the image capturing direction of the image capturing section 40 based on the amount of change for directing the image capturing section 40 to the plane mirror selected by the plane mirror selecting section 530, which is received from the plane mirror selecting section 530. More specifically, the image capturing target control section 540 provides the amount of change of the image capturing section 40 to the image capturing direction control section 80. Then, the image capturing direction control section 80 changes the direction of the image capturing section 40 to the plane mirror selected by the plane mirror selecting section 530 based on the amount of change of the image capturing section 40 which is received from the plane mirror selecting section 530. Thereby the target captured by the image capturing section 40 can be switched from the convex mirror section 20 to the plane mirror selected by the plane mirror selecting section 530. Here, when the changed direction specifying section 520 sets the priority to the region in which the behavior of the subject 900 is changed, the image capturing target control section 540 may change the image capturing direction of the image capturing section 40 based on the priority set by the changed direction specifying section 520.

Additionally, receiving information indicating that a change in the behavior of the subject 900 of the whole image is detected, the image capturing target control section 540 provides information indicating that the target captured by the image capturing section 40 is switched from the convex mirror section 20 to the plane mirror section 30 to the signal processing section 60 and the focus control section 70. Here, the image capturing target control section 540 may provide the amount of change for directing the image capturing section 40 to the direction of the plane mirror selected by the plane mirror selecting section 530 and the identifier of the plane mirror selected by the plane mirror selecting section 530 to the focus control section 70. The signal processing section 60 may provide the whole image captured by the image capturing section 40 to the whole image acquiring section 500, and also may provide the partial image captured by the image capturing section 40 to the partial image acquiring section 550 based on information received from the image capturing target control section 540, which indicates that the target captured by the image capturing section 40 is switched from the convex mirror section 20 to the plane mirror section 30. Here, the image capturing target control section 540 may turn back the target captured by the image capturing section 40 to the convex mirror section 20 after the partial image captured by the image capturing section 40 is acquired by the partial image acquiring section 550.

The focus control section 70 controls a focal distance of the image capturing section 40 dependent on which of the convex mirror section 20 or the plane mirror section 30 is the target captured by the image capturing section 40. Receiving information indicating that the target captured by the image capturing section 40 is switched from the convex mirror 20 to the plane mirror 30 from the image capturing target control section 540, the focus control section 70 adjusts the focal position of the image capturing section 40 to the plane mirror 30. Thereby the optical path difference due to changing the image capturing target from the convex mirror 20 to the plane mirror 30 can be corrected. The focus control section 70 may store the position of the plane mirror in association with the identifier to uniquely identify the plurality of plane mirrors of the plane mirror section 30, for example. Then, receiving the identifier of the plane mirror from the image capturing target control section 540, the focus control section 70 controls the focal distance of the image capturing section 40 based on the position of the plane mirror stored in the focus control section 70 in association with the identifier. Here, when the target captured by the image capturing section 40 is switched from the plane mirror section 30 to the convex mirror section 20, the focus control section 70 adjusts the focal position of the image capturing section 40 to the convex mirror section 20.

The partial image acquiring section 550 receives the partial image reflected by the plane mirror section 30, which is captured by the image capturing section 40 from the signal processing section 60 when the target captured by the image capturing section 40 is the plane mirror 30. Specifically, the partial image acquiring section 550 acquires the partial image of which number of pixels is more than that of the whole image acquired by the whole image acquiring section 500. Then, the partial image acquiring section 550 provides the received partial image to the image storage section 560. Here, when the monitoring system 10 captures a moving image, the whole image and the partial image are captured such that the number of pixels of the whole image is less than that of the partial image. Therefore, the capacity of the image storage section 560 can be saved.

The image storage section 560 stores the whole image received from the whole image acquiring section 500 in association with the identifier to uniquely identify the whole image. Additionally, the whole image storage section 560 also stores the partial image received from the partial image acquiring section 550 in association with the identifier to uniquely identify the partial image. The image storage section 560 provides the whole image and the partial image to the image output section 90. The image output section 90 outputs the whole image and the partial image received from the image storage section to a display device such as a monitor.

The monitoring system 10 may include a person recognizing section for recognizing a person captured as the subject 900. Thereby the person being the subject 900 can be specified using the partial image of which number of pixels is more than that of the whole image. For example, the monitoring system 10 may extract the facial image of the person from the partial image stored in the image storage section 560. The monitoring system 10 may further include a storage section for storing the facial image of a predetermined person. Then, the monitoring system may match the facial image extracted by the person recognizing section with the facial image stored in the storage section to specify the person shown on the partial image. Thereby it can be determined whether the person shown on the partial image is the person previously stored in the storage section.

The monitoring system 10 according to the present embodiment can monitor the behavior of the subject 900 during capturing the whole image including the room in all directions shown on the convex mirror 20. Additionally, the monitoring system 10 can switch the image capturing target from the convex mirror section 20 to the plane mirror section 30 when a change in the behavior of the subject 900 is detected. Then, the monitoring system 10 can capture the image of the subject 900 shown on the plane mirror. Thereby a high quality image of the subject 900 shown on the plane mirror can be captured.

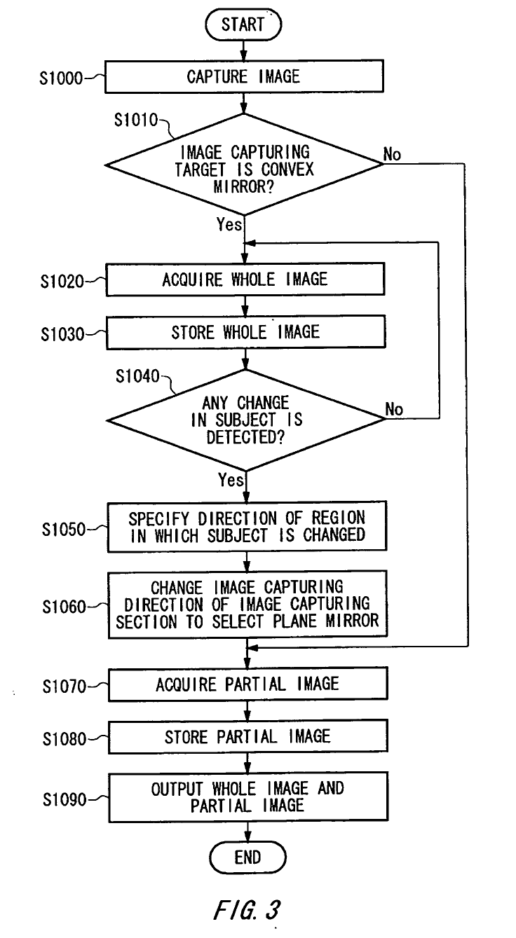

FIG. 3 is a flow chart showing a processing of the monitoring system 10. Firstly, the image capturing section 40 captures an image (S1000). Then, when a target captured by the image capturing section 40 is the convex mirror section 20 (S1010:Yes), the whole image appearing on the convex mirror section 20 and captured by the image capturing section 40 is acquired by the whole image acquiring section 500 through the signal processing section 60 (S1020). Next, the whole image acquired by the whole image acquiring section 500 is stored in the image storage section 560 (S1030). Additionally, the whole image acquiring section 500 provides the acquired whole image to the change detecting section 510. The change detecting section 510 detects a change in the behavior of the subject 900 of the whole image received from the whole image acquiring section 500 (S1040). Here, when any change in the behavior of the subject 900 of the whole image is not detected (S1040: No), the image capturing section 40 continuously captures the whole image until a change in the behavior of the subject 900 of the whole image is detected, and then, the captured whole image is provided to the change detecting section 510 through the whole image acquiring section 500.

Meanwhile, when the change detecting section 510 detects any change in the behavior of the subject 900 (S1040: Yes), the change detecting section 510 calculates the position of the image 910 of the subject 900 in the convex mirror section 20. Then, the change detecting section 510 provides information indicating that a change in the behavior of the subject 900 of the whole image is detected and positional information of the subject 900 in the convex mirror section 20 to the changed direction specifying section 520. Then, the changed direction specifying section 520 specifies the direction of the region in which the behavior of the subject 900 is changed in the convex mirror 20 based on the information received from the change detecting section 510, which indicates that a change in the behavior of the subject of the whole image is detected, and the positional information of the subject 900 in the convex mirror 20 to the changed direction specifying section 520. Then, the changed direction specifying section 520 specifies the direction of the region in which the behavior of the subject 900 is changed in the convex mirror section 20 based on the information received from the change detecting section 510, which indicates that a change in the behavior of the subject 900 of the whole image is detected, and the positional information of the subject 900 in the convex mirror section 20 (S1050).

The changed direction specifying section 520 specifies the direction of the region in which the behavior of the subject 900 is changed in the whole image acquired by the whole image acquiring section 500. The changed direction specifying section 520 may calculate the direction of the region in which the behavior of the subject 900 is changed based on the positional information of the subject 900 in the convex mirror section 20, which is received from the change detecting section 510. The changed direction specifying section 520 provides the information indicating that a change in the behavior of the subject 900 of the whole image is detected and information indicative of the direction specified as the direction of the region in which the behavior of the subject 900 is changed to the plane mirror selecting section 530.

The plane mirror selecting section 530 selects the plane mirror reflecting the partial image in the direction including the region in which the behavior of the subject 900 is changed, which is specified by the changed direction specifying section 520 to the direction of the image capturing section 40 (S1060). The plane mirror selecting section 530 provides information indicating that a change in the behavior of the subject 900 of the whole image is detected, the identifier of the selected plane mirror and the amount of change for directing the image capturing section 40 to the direction of the selected plane mirror to the image capturing target control section 540. Then, the image capturing target control section 540 provides the amount of change of the image capturing section 40 to the image capturing direction control section 80. Next, the image capturing direction control section 80 switches the target captured by the image capturing section 40 from the convex mirror section 20 to the plane mirror section 30 based on the amount of change of the image capturing section 40, which is received from the image capturing target control section 540.

Next, the image capturing section 40 captures the partial image shown on the plane mirror selected by the plane mirror selecting section 530 (S1070). Here, when the target captured by the image capturing section 40 is not the convex mirror section 20 in the S1010 (S1010:No), the image capturing section 40 may capture the partial image shown on the plane mirror because the target captured by the image capturing section 40 is the plane mirror section 30 (S1070). The partial image acquiring section 550 receives the partial image captured by the image capturing section 40 through the signal processing section 60. Then, the partial image acquiring section 550 provides the acquired partial image to the image storage section 560. Then, the image storage section 560 stores the partial image in association with the identifier to uniquely identify the partial image (S1080). The image storage section 560 provides the stored whole image and partial image to the image output section 90. Then, the image output section 90 outputs the whole image and the partial image to such as a monitor (S1090).

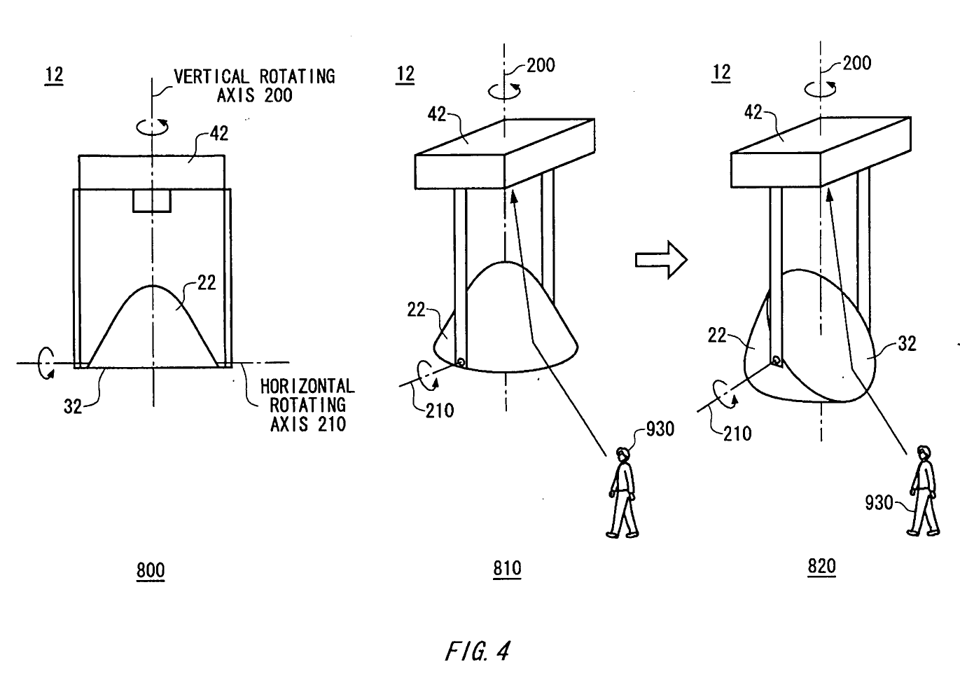

FIG. 4 is a conceptual diagram of a monitoring system 12 according to a second embodiment of the present invention. The monitoring system 12 includes a convex mirror section 22, a plane mirror section 32, an image capturing section 42, a vertical rotating axis 200 and a horizontal rotating axis 210. The monitoring system 12 captures a whole image on which the room in all directions is shown, which is shown on the convex mirror 22 when a subject 930 such as a person is not shown on the convex mirror 22. Then, when the subject 930 enters the room and the behavior of the subject 930 is changed, the monitoring system 12 captures the partial image including the subject 930, which shown on the plane mirror section 32. The monitoring system 12 according to the present embodiment aims to monitor a room in all directions and to capture the high quality image of the subject 930 when it is detected that any change in the behavior of the subject 930 is detected.

In the monitoring system 12, the image capturing section 42 is disposed on the ceiling of the room. Then, the plane mirror section 32 is disposed on the rear face of the convex mirror section 22. The convex mirror section 22 and the plane mirror section 32 are disposed below the image capturing section 42. Further, as shown in a sectional view 800 of the monitoring system 12, the convex mirror section 22 and the plane mirror section 32 can be rotated along the vertical direction by the horizontal rotating axis 210. Additionally, the convex mirror section 22 and the plane mirror section 32 can be rotated along the horizontal direction by the vertical rotating axis 200.

When there is no subject 930 in an image capturing region in the initial state, the target captured by the image capturing section 42 is set to the convex mirror section 22 and the image capturing section 42 captures the surrounding whole image reflected by the convex mirror 22 as shown in an example 810 of the monitoring system 12. Then, when the subject 930 enters the room, the monitoring system 12, as shown in the example 810 and an example 820 of the monitoring system 12, operates as follows. Firstly, the whole image captured by the image capturing section 42 before the subject 930 is captured is compared with the whole image on which the image of the subject 930 reflected by the convex mirror section 22 is shown to detect whether the behavior of the subject 930 is changed or not and the movement of the subject 930. Next, when it is detected that the behavior of the subject 930 is changed, the orientation of the plane mirror section 32 is changed such that the convex mirror section 22 is reversed to direct the orientation of the image of the subject 930 shown on the plane mirror section 32 to be captured by the image capturing section 42. Then, the image capturing section 42 captures the image of the subject 930 shown on the plane mirror section 32.

The monitoring system 12 according to the present embodiment can monitor the room in all directions through the convex mirror section 22 and monitor the behavior of the subject 930. Additionally, the monitoring system 12 can capture the subject 930 through the plane mirror 32 when a change in the behavior of the subject 930 is detected. Thereby while the monitoring system 12 can monitor the room in all directions, the high quality image of the subject 930 can be captured when a change in the behavior of the subject 930 is detected. Additionally, the monitoring system 12 can specify the person being the subject 930 using the high quality image of the subject 930 captured through the plane mirror section 32.

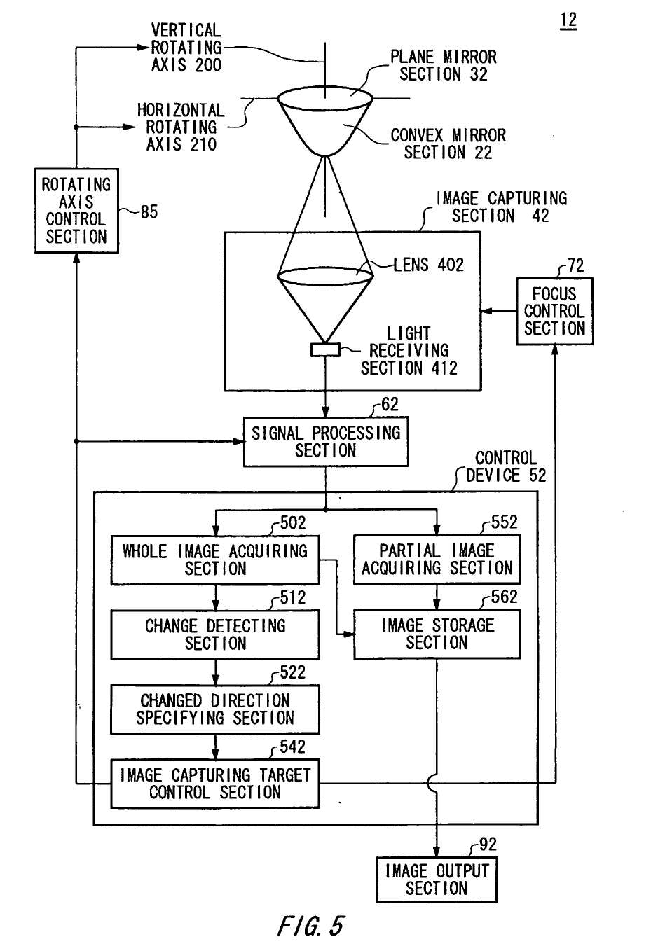

FIG. 5 is a block diagram of the functional configuration of the monitoring system 12 according to the second embodiment. The monitoring system 12 includes the convex mirror section 22, the plane mirror section 32, the image capturing section 42, a control device 52, a signal processing section 62, a focus control section 72, a rotating axis control section 85, an image output section 92, the vertical rotating axis 200 and the horizontal rotating axis 210. The image capturing section 42 includes a lens 402 and a light receiving section 412. The control device 52 includes a whole image acquiring section 502, a change detecting section 512, a changed direction specifying section 522, an image capturing target control section 542, a partial image acquiring section 552 and an image storage section 562. Here, the convex mirror section 22, the plane mirror section 32, the image capturing section 42, the control device 52, the signal processing section 62, the focus control section 72, the horizontal rotating axis 210, the lens 402, the light receiving section 412, the whole image acquiring section 502, the change detecting section 412, the changed direction specifying section 522, the image capturing target control section 542, the partial image acquiring section 552 and the image storage section 562 have the function the same as that of each components having the same reference numeral above described with reference to FIG. 2, so that the repeated description is omitted.

The convex mirror section 20 reflects the whole image surrounding the convex mirror 20 to the direction of the image capturing section 42. Meanwhile, the plane mirror section 32 reflects the partial image included in the whole image reflected by the convex mirror section 22 to the direction of the image capturing section 42. In the monitoring system 12, the mirror section 32 is disposed on the rear face of the convex mirror section 22.

The change direction specifying section 522 specifies the direction of the region in which the behavior of the subject 930 is changed in the whole image acquired by the whole image acquiring section 502 when the change detecting section 512 detects a change in the behavior of the subject 930 of the whole image. Then, the changed direction specifying section 522 provides information on the direction of the region in which the specified subject 930 is changed to the image capturing target control section 542. The image capturing target control section 542 calculates a rotating angle for rotating the plane mirror section 32 along the horizontal direction and the vertical direction such that the plane mirror section 32 is directed to the direction of the region in which the subject 930 specified by the change direction specifying section 522 is changed. Then, the image capturing target control section 542 provides information on the calculated rotating angle to the rotating axis control section 85.

The rotating axis control section 85 rotates the horizontal rotating axis 210 based on the information on the rotating angle for rotating the plane mirror section 32 along the vertical direction, which is received from the image capturing target control section 542 to reverse the convex mirror section 22. Next, the rotating axis control section 85 rotates the vertical rotating axis 200 based on the rotating angle for rotating the orientation of the plane mirror section 32 along the horizontal direction received from the image capturing target control section 542 in the direction of the region specified by the changed direction specifying section 522 to change the same. Thereby the rotating axis control section 85 switches the target captured by the image capturing section 42 from the convex mirror section 22 to the plane mirror section 32.

The monitoring system 12 according to the present embodiment can capture the whole image including the room in all directions shown on the convex mirror section 22 to monitor the behavior of the subject 930. Additionally, the monitoring system 12 can reverse the convex mirror 22 to switch the image capturing target to the plane mirror 32 when a change in the behavior of the subject 930 is detected during capturing the whole image shown on the convex mirror section 22. Then, the monitoring system 12 can capture the image of the subject 930 shown on the plane mirror section 32. Thereby the place in which the monitoring system 12 is installed can be compact while the monitoring system 12 can monitor the behavior of the subject 930 and capture the high quality image of the subject 930 shown on the plane mirror.

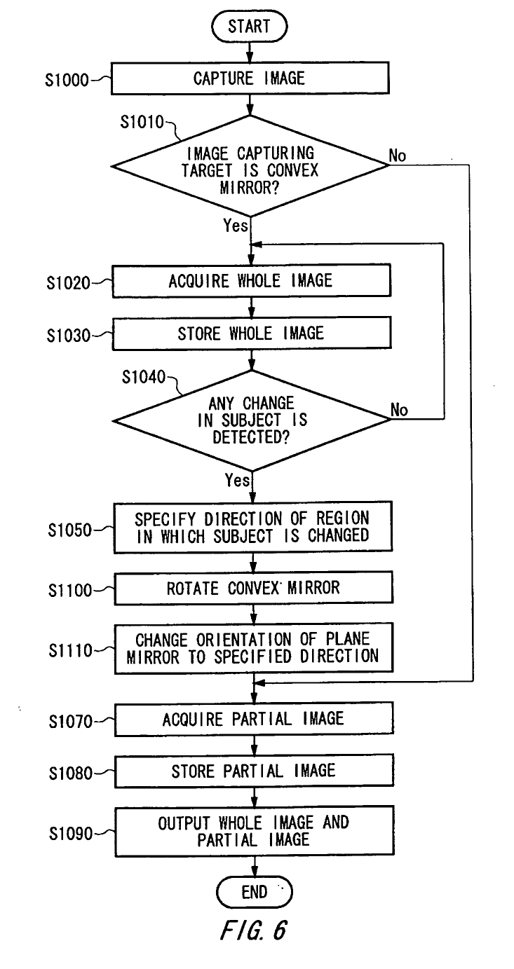

FIG. 6 is a flowchart showing a processing of the monitoring system 12. Here, each step of S1000-S1050 and S1070-S1090 has function substantially the same as that of each components having the same reference numeral above-described with reference to FIG. 3, so that the repeated description is omitted.

Firstly, the changed direction specifying section 522 specifies the direction of the region in which the behavior of the subject 930 is changed in the convex mirror section 22 (S1050). Then, the image capturing target control section 542 the behavior of the subject 930 is changed, which is specified by the changed direction specifying section 522. Then, the image capturing target control section 542 calculates the rotating angle of the plane mirror section 32 in order to direct the plane mirror section 32 to the direction of the region in which the behavior of the subject 930 is changed, which is specified by the changed direction specifying section 522, for example. Then, the image capturing target control section 542 provides the calculated information on the rotating angle to the rotating angle control section 85. Next, the rotating axis control section 85 controls the horizontal rotating axis 210 to rotate the convex mirror section 22 so that the plane mirror section 32 directs to the subject 930 (S1100). Then, the rotating axis control section 85 controls the vertical rotating axis 200 to change the direction of the plane mirror section 32 to the direction of the region in which the subject 930 specified by the changed direction specifying section 522 is changed (S1110).

While the present invention have been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. A monitoring system comprising:
an image capturing section;
a convex mirror section for reflecting a surrounding whole image to the direction of the image capturing section;
a plane mirror section for reflecting a partial image included in the whole image reflected by the convex mirror section to the direction of the image capturing section;
a control device for controlling to switch a target captured by the image capturing section between the convex mirror or the plane mirror, wherein
the control device including:
a whole image acquiring section for acquiring a whole image reflected by the convex mirror when the target captured by the image capturing section is the convex mirror;
a change detecting section for detecting a change in the subject of the whole image acquired by the whole image acquiring section;
an image capturing target control section for switching the target captured by the image capturing section from the convex mirror to the plane mirror when the change detecting section detects the change in the subject of the whole image; and
a partial image acquiring section for acquiring a partial image reflected on the plane mirror when the target captured by the image capturing section is the plane mirror.

2. The monitoring system according to claim 1, wherein
the plane mirror section includes a plurality of plane mirrors continuously disposed along the circumference of the convex mirror section, for reflecting each of the plurality of partial images included in the whole image reflected by the convex mirror to the direction of the image capturing section.
the control device further includes:
a changed direction specifying section for specifying the direction of a region in which the behavior of the subject is changed in the whole image acquired by the whole image acquiring section when the change detecting section detects the change in the subject of the whole image; and
a plane mirror selecting section for selecting the plane mirror which reflects the partial image in the direction specified by the changed direction specifying section to the direction of the image capturing section,
the image capturing target control section changes the image capturing direction of the image capturing section to switch the target captured by the image capturing section from the convex mirror section to the plane mirror selected by the plane mirror selecting section.

3. The monitoring system according to claim 2, wherein
the convex mirror section and the plane mirror section are disposed on a ceiling of a room, and
the image capturing section is disposed below the convex mirror section.

4. The monitoring system according to claim 1, wherein
the plane mirror section is disposed on the rear face of the convex mirror section,
the control device further includes a changed direction specifying section for specifying the direction of the region in which the behavior of the subject is changed in the whole image acquired by the whole image acquiring section when the change detecting section detects that the behavior of the subject of the whole image is changed, and
the image capturing target control section reverses the convex mirror section to switch the target captured by the image capturing section from the convex mirror section to the plane mirror section and changes the orientation of the plane mirror section to the direction of the region specified by the changed direction specifying section.

5. The monitoring system according to claim 4, wherein
the image capturing system is disposed on the ceiling of the room; and
the convex mirror section and the plane mirror section are disposed below the image capturing section.

6. The monitoring system according to claim 5 further comprising:
a horizontal rotating axis for rotating the convex mirror and the plane mirror along the vertical direction; and
a vertical rotating axis for rotating the convex mirror and the plane mirror along the horizontal direction, wherein
the image capturing target control section switches the target captured by the image capturing section from the convex mirror section to the plane mirror section by rotating the horizontal rotating axis to reverse the convex mirror, and changes the orientation of the plane mirror section to the direction of the region specified by the changed direction specifying section by rotating the vertical rotating axis.

7. The monitoring system according to claim I further comprising a focus control section for controlling a focal position of the image capturing section dependent on whether the target captured by the image capturing section is the convex mirror section or the plane mirror section.

8. The monitoring system according to claim 1, wherein the partial image acquiring section acquires the partial image of which number of pixels is more than the number of pixels of the whole image acquired by the whole image acquiring section.
